(19) United States
(12) Patent Application Publication
(10) Pub. No.: US 2022/0351303 A1
(43) Pub. Date: Nov. 3, 2022

(54) System and Method for Automated Acquisition and Integration of Survey Data

(71) Applicant: Payscale, Seattle, WA (US)

(72) Inventors: Adam PHILLABAUM, Seattle, WA (US); Bryan KIELPINSKI, Cetennial, CO (US); Elizabeth COOPER, Northglenn, CO (US); Thomas JOHNSON, Kent, WA (US)

(73) Assignee: Payscale, Seattle, WA (US)

(21) Appl. No.: 17/732,138

(22) Filed: Apr. 28, 2022

Related U.S. Application Data
(60) Provisional application No. 63/180,841, filed on Apr. 28, 2021.

(51) Int. Cl. G06Q 40/00

(52) U.S. Cl. CPC G06Q 40/125

(57) ABSTRACT

According to one aspect of the invention, a dynamic, computer enabled, transformative process includes a plurality of steps, wherein raw data is first detected, flattened, transformed, and mapped to a new set of headers and/or reordered as needed to facilitate a wide variety of survey export formats uploadable to products useful by clients using associated software. According to other aspects, the file detection process automates a historic process of opening files and looking at certain attributes of the file format to confirm that the file is a certain survey from a publisher and handled appropriately after the metadata information is detected from the raw file. File formats are detected using a combination of file attributes and pattern recognition; for example, filenames, the number of sheets in a workbook, and the number of words in workbook might be appropriate file attributes in a particular application.

### FIELD

The present invention relates generally to payroll data systems and methods used to automate the process of translating compensation survey data into delivery form suitable for inclusion in one or more associated survey data products.

### BACKGROUND

In the field of employee compensation, fresh data is one of the major ways that companies are able to remain competitive by paying their employees a fair wage, thereby allowing their employees to both feel valued within the company and to earn a sufficiently secure position for which they are compensated fairly as to remain at a reasonable compensation level.

Companies have historically purchased available compensation data from large companies that have the resources and processes in place to properly aggregate such data. Companies typically participate in such surveys by submitting their data to surveyors, which return information that has already been aggregated, anonymized, and categorized within meaningful segments; for example, national pay trends, metropolitan area pay differentials, and relative company sizes are frequently used as meaningful segment categories.

Human Resources and/or compensation professionals buy and download these results when the surveys are published. Such data is then used by the buyer, either raw or in spreadsheet form. In some instances, the compiled data is submitted to compensation software solution companies to get the data into such products in order to alleviate the difficulty of manipulating data in a spreadsheet from multiple sources.

The format in which the results data are published varies widely from survey publisher to survey publisher. Historically, these varying export formats had been converted manually in spreadsheets to a desired format that would allow for importing the data into the desired products. These transformations include multi-column concatenation, conditional concatenation, table transposals, and multi-table lookups for constructing Job Titles and Job Codes, appropriately.

In view of the foregoing, there is a clear need for the processes and transformations described here in. For example, while the resulting data are very valuable, many prior unsuccessful attempts to standardize such presentations and add new techniques and processes have historically failed to provide the results needed by the industry.

### SUMMARY

In one example embodiment, the method standardizes a plurality of variable and scalable historically manual transformations. In other words, customized presentations can be created and integrated that capture, all, some or few of the traditional factors; or instead incorporate essentially customized results capable of integration into third-party products by customers wishing their data to be presented on a so-called white glove delivery basis.

In a specific though non-limiting embodiment, the process is divided into at least 4 steps, wherein the raw data is detected, flattened, transformed, and mapped to a new set of headers and/or reordered as needed to facilitate a wide variety of survey export formats uploadable to products useful by clients using associated software.

In other embodiments, file detection automates a historic process of opening files and looking at certain attributes of the file format to confirm that the file is a certain survey from a publisher and handled appropriately after the metadata information is detected from the raw file. File formats are detected using a combination of file attributes and pattern recognition; for example, filename(s), the number of sheets in a workbook, and the number of words in workbook might be appropriate file attributes in a particular application.

In further embodiments, using information gathered during the automated file detection phase, the file is then “flattened” to the relevant table of survey data. Flattening a file could include a plurality of commands, headers, etc., to help arrive at the volume and character of data needed by the customer; for example, removing superfluous header rows above a table as well as removing any extra rows below table data that do not belong in that particular table.

In a still further embodiment, the table data has been removed and flattened from the raw file and is ready for transformations to be applied to the data.

In various other embodiments, data are represented in the thousands (Example “50.52”) would have a thousands multiplier applied (for example, “50,520.00”); columns such as currency are added for all records so that each record has an associated currency; multiple columns are concatenated or conditionally concatenated to create distinct data records; placeholders data such as hash marks, hyphens, asterisks, etc., are cleaned up from cells where no compensation data was provided; and/or organization/incumbent weighted data is split apart & tagged appropriately, all transformed variably and scalably as necessary for the application.

Headers in spreadsheets commonly span multiple rows and are merged with their accompanying cells of data to construct unique headers; see Table A below for an example of multi-row headers that need to be constructed to form distinct headers (Example: “Base Salary 25^{th}”).

In further embodiments still, once the transformations are complete, the data are ready for mapping to an internal mapping header that will then load the data to a certain field within certain products. In one specific though limiting embodiment, data are mapped to internal fields and rearranged as needed to transform the data into an uploadable format.

In such manner, data files are processed, transformed, and made available for use in the desired products, without human intervention needed to manually process or transform the desired compensation survey export format.

In other embodiments, certain formats require intensive filtering and joining. For example, in certain tables all percentile data are consolidated into a single set, of columns, while certain columns need to be filtered (or “pivoted”) further to gather the data for a particular record.

In other embodiments, the instant method admits to filtering by percentile element, and then joining the resultant data into a more conventional table with pay elements and percentile spread across many columns, thereby allowing for more conventional importability into a database in which a single row is a record of data.

In certain embodiments, the formats have a plurality of columns in which to pivot or filter the data further during the original filtering and joining process. See Tables B & C for an example of such transformations, where “Pay Element” serves as a useful pivot for the sake of description, though ordinarily skilled artisans will appreciate that the example(s) presented herein have been greatly simplified only to show the basic transformation process that occurs.

Though the present invention has been depicted and described in detail above with respect to several exemplary embodiments, those of ordinary skill in the art will also appreciate that minor changes to the description, and various other modifications, omissions and additions may also be made without departing from either the spirit or scope thereof

TABLE A

| Job | Job | | Base Salary | | | | Total Cash | | |
|---|---|---|---|---|---|---|---|---|---|
| Title | Code | Datacut | 25^{th} | 50^{th} | Avg | 75^{th} | 25^{th} | 50^{th} | 75^{th} |
| Accountant | 123 | National | 45.0 | 45.5 | 50.0 | 50.5 | 55.0 | 55.5 | 60.0 |
| Accountant | 123 | NYC | 45.1 | 45.6 | 50.1 | 50.6 | 55.1 | 55.6 | 60.1 |
| | | Metro | | | | | | | |

TABLE B

| Job | Job | | Pay | | | | |
|---|---|---|---|---|---|---|---|
| Title | Code | Datacut | Element | 25^{th} | 50^{th} | Avg | 75^{th} |
| Accountant | 123 | National | Base | 40.5 | 50.0 | 50.5 | 60.0 |
| | | | Salary | | | | |
| Accountant | 123 | National | Total | 41.5 | 51.5 | 52.5 | 62.5 |
| | | | Cash | | | | |
| Sr. | 124 | National | Base | 42.5 | 52.0 | 52.5 | 62.0 |
| Accountant | | | Salary | | | | |
| Sr. | 124 | National | Total | 43.5 | 53.5 | 54.5 | 64.5 |
| Accountant | | | Cash | | | | |

TABLE C

| | | | Base | Base | Base | Base | Total | Total | Total | Total |
|---|---|---|---|---|---|---|---|---|---|---|
| Job | Job | | Salary | Salary | Salary | Salary | Cash | Cash | Cash | Cash |
| Title | Code | Datacut | 25^{th} | 50^{th} | Avg | 75^{th} | 25^{th} | 50^{th} | Avg | 75^{th} |
| Accountant | 123 | National | 40.5 | 50.0 | 50.5 | 60.0 | 41.5 | 51.5 | 52.5 | 62.5 |
| Sr. | 124 | National | 42.5 | 52.0 | 52.5 | 62.0 | 43.5 | 53.5 | 54.5 | 64.5 |
| Accountant | | | | | | | | | | |

1. A dynamic, computer enabled, transformative method comprising a plurality of steps, said steps comprising:
a first step wherein raw data is detected, flattened, transformed, and mapped to a new set of headers and/or reordered as needed to facilitate a wide, variety of survey export formats uploadable to products useful by clients using associated software;
a second step wherein the file detection process automates a historic process of opening files and looking at certain attributes of the file format to confirm that the file is a certain survey from a publisher and handled appropriately after the metadata information is detected from the raw file;
and a third step wherein file formats are detected using a combination of file attributes and pattern recognition, for example, filenames, the number of sheets in a workbook, and the number of words in workbook are appropriate file attributes in a particular application.
